(19) United States
(12) Patent Application Publication
(10) Pub. No.: US 2008/0123848 A1
(43) Pub. Date: May 29, 2008

(54) System and method for data security, encryption apparatus and decryption apparatus

(75) Inventors: Song QIU, Beijing (CN); Yuan Wang, Beijing (CN); AnJun Chen, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/944,606

(22) Filed: Nov. 24, 2007

(30) Foreign Application Priority Data
Nov. 24, 2006 (CN) 200610145359.3

(51) Int. Cl. H04N 1/44

(52) U.S. Cl. 380/245

(57) ABSTRACT

Techniques pertaining to encrypting or decrypting image data being transmitted between two points are disclosed. According to one aspect of the present invention, the image data is divided into a plurality of data blocks that are then scrambled in accordance with a given sequence. Without knowing the order of the given sequence, the image data, even if received by an unauthorized party, is not legible. On the other end, the rearranged image data is received in a receiving device that is configured to divide the image data into a corresponding plurality of data blocks, and rearrange the blocks according to the given sequence to recover the original image data.

### BACKGROUND OF THE INVENTION

1. Field of the Invention

The present invention relates to the techniques for communication security, and more particularly to system and method for data security, an encryption apparatus and a decryption apparatus.

2. Description of Related Art

With the development of radio frequency techniques, transmitting image signal lively via a wireless network becomes more popular, thus security question starts to get a particular attention. To secure image transmission from one place to another, it is needed to encrypt the image signal being wirelessly transmitted for security. As used herein, video signals are also referred as to a type of special image signals, namely continuously moving image signals.

Currently, two means is provided for encrypting the image signal during the wireless transmission. Referring to FIG. 1A, which shows a first means for encrypting the image signal during the wireless transmission, the image signal is encrypted in a signal source terminal, the encrypted image signal is transmitted via a radio frequency (RF) channel subsequently, and the encrypted image signal is decrypted in a signal destination terminal finally. Referring to FIG. 1B, which shows a second means for encrypting the image signal during the wireless transmission, the image signal is encrypted in the RF transmitting channel and the encrypted image signal is decrypted in the RF receiving channel.

If the image signal is encrypted in the RF transmitting channel, the image signal is needed to be firstly encoded according channel encoding at the signal source terminal. In addition, for eliminating noise interference during the wireless transmission, forward error correction may also be applied on the image signal at the signal source terminal. Thus, processing of the image signal may be very complex and the cost for data security increases. Hence, encrypting the image signal in the signal source terminal may be a preferred means for some normal image signal transmission system, such as conventional TV system.

The means of encrypting image signal in the signal source terminal mainly comprises two types of ways, one is to change pixel values and the other is to disturb individual pixel addresses. Although the way of changing pixel values such as transforming a pixel value in time domain into a pixel value in frequency domain according to Fast Fourier Transform algorithm (FFT) can encrypt the image signal efficiently, the encrypted pixel value currently transmitted may be changed due to influence of low pass filtering during encoding/decoding the image signal so that the process of decrypting the image signal become very difficult. There are a lot of specific ways to disturb pixel address, such as depending on chaotic sequence, m sequence etc. Theses specific ways have a common ground that the image signal is encrypted by disturbing arrangement sequence of pixels according to characters of the image signal. However, this type of encryption way requires a great of calculation and also results the decryption of the image signal difficult. Furthermore, the manufacture cost is often too high to provide a buffer for buffering a whole field of the image data.

Thus, improved techniques for encrypting image signal are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to encrypting or decrypting image data being transmitted between two points. According to one aspect of the present invention, the image data is divided into a plurality of data blocks that are then scrambled in accordance with a given sequence. Without knowing the order of the given sequence, the image data, even if received by an unauthorized party, is not legible. On the other end, the rearranged image data is received in a receiving device that is configured to divide the image data into a corresponding plurality of data blocks, and rearrange the blocks according to the given sequence to recover the original image data.

According to another aspect of the present invention, an encryption key is predetermined or generated according to a given algorithm. A dividing point generator generates a dividing point depending on an encryption key. A block dividing unit divides image data into a plurality of image data blocks based on the received dividing point and outputs the image data blocks to a block rearranging unit. The block rearranging unit rearranges the image data blocks according to a given sequence. Thus, the image data is so encrypted by disturbing the original arrangement sequence of the image data blocks. It should be noted that the image data may be encrypted line by line, block by block or frame by frame. The description is essentially an inversed operation of the encryption.

The present invention may be implemented as a system, an apparatus or an integrated circuit. According to one embodiment, the present invention is a method for data security, the method comprises generating a number of encryption dividing points in accordance with an encryption key, dividing image data into a plurality of image data blocks according to the encryption dividing points, rearranging the image data blocks according to a given sequence to produce encrypted image data. The method further comprises generating a number of dividing points in accordance with a decryption key, dividing the encrypted image data into a plurality of image data blocks according to the decryption dividing points, a number of the image data blocks that have been divided identical with a number of the corresponding image data blocks divided according to the dividing points, and replacing the image data blocks according to the given sequence to produce decrypted image data.

According to another embodiment, the present invention is a system for data security, the system comprises an encryption apparatus comprising:
a dividing point generator for generating a group of encryption dividing points depending on an encryption key;
a block dividing unit for dividing image data into a plurality of image data blocks based on the group of encryption dividing points; and
a block rearranging unit for rearranging the image data blocks according to a given sequence to produce encryption image data;
and a decryption apparatus comprising:
a dividing point generator for generating a group of decryption dividing points depending on a decryption key;
a block dividing unit for dividing encrypted image data into image data blocks being identical with corresponding image data blocks divided in the encryption apparatus based on the group of decryption dividing points; and
a block replacing unit for replacing the image data blocks according to the given sequence to produce decryption image data.

One of the features, benefits and advantages in the present invention is to provide a communication means for transmitting image data from one place to another without complicated computation in a traditional encryption method.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A is a schematic block diagram showing a first conventional means for encrypting image data during wireless transmission;

FIG. 1B is a schematic block diagram showing a second conventional means for encrypting image data during wireless transmission;

FIG. 2 is a schematic block diagram showing an apparatus for encrypting image data according to one embodiment of the present invention;

FIG. 3A is a schematic block diagram showing a first embodiment of a dividing point generator of the apparatus shown in FIG. 2 according to one embodiment of the present invention;

FIG. 3B is a schematic block diagram showing a second embodiment of the dividing point generator of the apparatus shown in FIG. 2 according to one embodiment of the present invention;

FIG. 3C is a schematic block diagram showing a third embodiment of the dividing point generator of the apparatus shown in FIG. 2 according to one embodiment of the present invention;

FIG. 4 is a schematic view showing a Pseudo random binary sequence generator of the dividing point generator of the apparatus shown in FIG. 2 according to one embodiment of the present invention;

FIG. 5 is a schematic flowchart showing a method for encrypting image data according to one embodiment of the present invention;

FIG. 6 is a schematic block diagram showing an apparatus for decrypting image data according to one embodiment of the present invention;

FIG. 7 is a schematic flowchart showing a method for decrypting image data according to one embodiment of the present invention; and

FIG. 8 is a schematic block diagram showing a system for encrypting/decrypting image data according to one embodiment of the present invention.

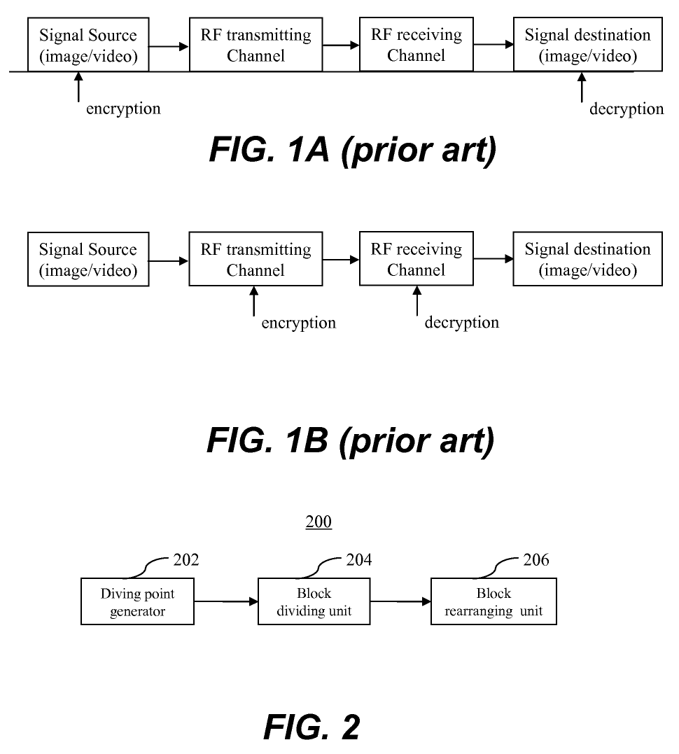

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 2-8. However, those skilled in the art will readily appreciate that the detailed description given herein with respect to these figures is for explanatory purposes only as the invention extends beyond these limited embodiments.

FIG. 2 is a schematic block diagram showing an apparatus for encrypting image data according to one embodiment of the present invention. In FIG. 2, the encryption apparatus 200 comprises a dividing point generator 202, a block dividing unit 204 and a block rearranging unit 206. The dividing point generator 202 generates a dividing point depending on an encryption key and outputs the dividing point to the block dividing unit 204. The encryption key includes a plurality of 8-bit integer data in one embodiment. The encryption key may be predetermined or may be generated according to a given algorithm. The block dividing unit 204 divides image data into a plurality of image data blocks based on the received dividing point and outputs the image data blocks to the block rearranging unit 206. The block rearranging unit 206 rearranges the image data blocks according to a given sequence. Thus, the image data can be encrypted by disturbing the original arrangement sequence of the image data blocks. It should be noted that the image data may be encrypted line by line, block by block or frame by frame. Namely, one line of, one block of or one frame of image data may be encrypted by the encryption apparatus 200 at a time.

The number of image data blocks divided by the block dividing unit 204 may be predetermined. Accordingly, the dividing point generator 202 is required to provide a corresponding number of dividing points. Namely, the number of image data blocks corresponds to the number of dividing points. A corresponding number of dividing points for one line of the image data can be set as one group. For example, if one line of the image data is divided into three image data blocks, two dividing points are needed. The more the number of the image data blocks is divided from one line of the image data, the better the encryption effect becomes. The dividing point generator 202 may provide one dividing point or several dividing points to the block dividing unit 204 at a time. For example, if the image data is divided into three image data blocks, the dividing point generator 202 may provide two dividing points to the block dividing unit 204 by one times, or the dividing point generator 202 may also provide two dividing points to the block dividing unit 204 twice.

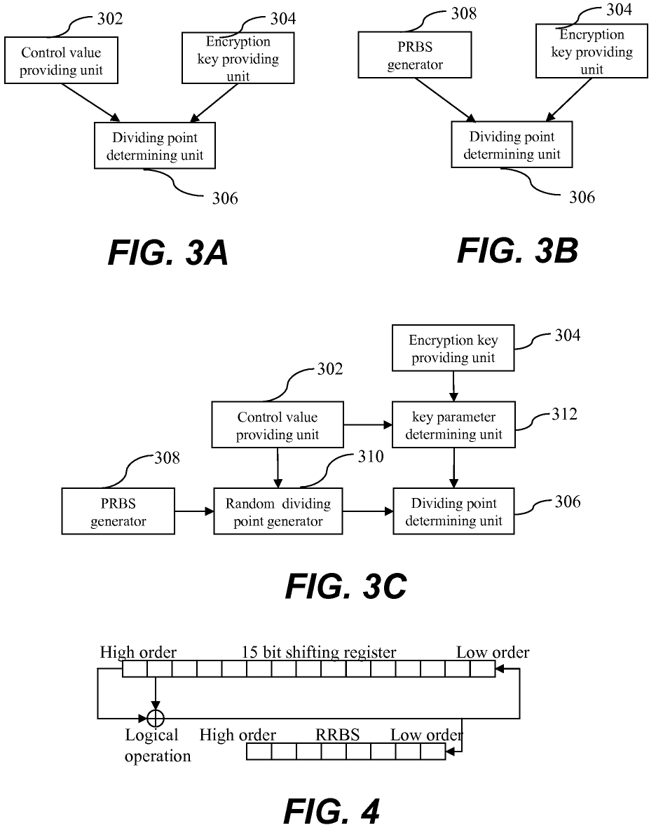

Several embodiments of the dividing point generator 202 are illustrated hereinafter for further understanding. FIG. 3A is a schematic block diagram showing a first embodiment of the dividing point generator 202 according to one embodiment of the present invention. In FIG. 3A, the dividing point generator 202 comprises a control value providing unit 302, an encryption key providing unit 304 and a dividing point determining unit 306.

The control value providing unit 302 is configured for providing a control value for the dividing point determining unit 306. The control value providing unit 302 may be implemented as a storage unit for storing a predetermined control value. The control value providing unit 302 may also be implemented as a processing unit for generating a control value according to a given algorithm. The encryption key providing unit 304 is configured for providing the encryption key for the dividing point determining unit 306. The encryption key includes a plurality of 8-bit integer data in one embodiment. The encryption key providing unit 304 may be implemented as a storage unit for storing the predetermined encryption key. The encryption key providing unit 304 may also be implemented as a processing unit for generating the encryption key according to a given algorithm. The dividing point determining unit 306 is configured for generating the dividing point according to the received control value and encryption key, such as selecting one integer data from the integer data of the encryption key as the dividing point. For example, if the control value received by the dividing point determining unit 306 is 5, the fifth integer data from low order to high order of the encryption key is selected as the dividing point. If the image data requires to be divided into at least two image data blocks, a corresponding number of the dividing points is generated by the dividing point generator.

FIG. 3B is a schematic block diagram showing a second embodiment of the dividing point generator 202 according to one embodiment of the present invention. In FIG. 3B, the dividing point generator 202 comprises a Pseudo Random Binary Sequence (PRBS) generator 308, an encryption key providing unit 304 and a dividing point determining unit 306.

The PRBS generator 308 is configured for generating a PRBS for the dividing point determining unit 306. The encryption key providing unit 304 is configured for providing the encryption key for the dividing point determining unit 306. The encryption key includes a plurality of 8-bit integer data in one embodiment. The encryption key providing unit 304 may be implemented as a storage unit for storing the predetermined encryption key. The encryption key providing unit 304 may also be implemented as a processing unit for generating the encryption key according to a given algorithm. The dividing point determining unit 306 is configured for generating the dividing point according to the received PRBS and the received encryption key, such as making a logic operation to the received PRBS and the received encryption key and taking the result of the logic operation as the dividing point. The logic operation may be an XOR operation, an AND operation, an OR operation, or an NXOR operation etc.

FIG. 3C is a schematic block diagram showing a third embodiment of the dividing point generator 202 according to one embodiment of the present invention. In FIG. 3C, the dividing point generator 202 comprises a Pseudo Random Binary Sequence (PRBS) generator 308, a control value providing unit 302, a random dividing point generator 310, an encryption key providing unit 304, a key parameter determining unit 312 and a dividing point determining unit 306.

The PRBS generator 308 is configured for generating a PRBS for the random dividing point generator 310. The control value providing unit 302 is configured for providing a control value for the random dividing point generator 310 and the key parameter determining unit 312. The control value providing unit 302 may be implemented as a storage unit for storing a predetermined control value. The control value providing unit 302 may also be implemented as a processing unit for generating a control value according to a given algorithm. The random dividing point generator 310 is configured for generating a random dividing point for the dividing point determining unit 306 according to the received control value, such as making a logic operation to the received PRBS and the received control value and taking the result of the logic operation as the random dividing point. The logic operation may be an XOR operation, an AND operation, an OR operation, or a NXOR operation etc. The encryption key providing unit 304 is configured for providing the encryption key for the key parameter determining unit 312. The encryption key consists of a plurality of 8-bit integer data. The encryption key providing unit 304 may be implemented as a storage unit for storing the predetermined encryption key. The encryption key providing unit 304 may also be implemented as a processing unit for generating the encryption key according to a given algorithm. The key parameter determining unit 312 is configured for determining a key parameter according to the received encryption key and the received control value and outputting the key parameter to the dividing point determining unit 306, such as selecting one integer data from the plural integer data of the encryption key as the key parameter. For example, if the control value received by the key parameter determining unit 312 is 7, the seventh integer data from low order to high order of the encryption key is selected as the key parameter. The dividing point determining unit 306 is configured for determining the dividing point according to the received random dividing point and the received key parameter, such as making a logic operation to the received random dividing point and the received key parameter and taking the result of the logic operation as the dividing point. The logic operation may be an XOR operation, an AND operation, an OR operation, or a NXOR operation etc.

As shown in FIG. 4, a shifting register may be implemented as the PRBS generator 308. A 15-bit shifting register is taken as an example for explaining an operation principle of the RRBS generator 308 hereafter. In practice, other shifting registers such as a 9-bit shifting register, an 11-bit shifting register or a 14-bit shifting register are also available for the PRBS generator 308.

The 15-bit shifting register is initialized under the control of a sync signal. The two highest order bits of the 15-bit shifting register are made a logic operation such as an XOR operation, an AND operation, an OR operation, or an NXOR operation with each other in one period of the sync signal. Subsequently, the 15-bit shifting register shifts left with one bit and the result of the logical operation is stored into the lowest order bit of the 15-bit shifting register. Simultaneously, the result of the logical operation is outputted as one binary digit of the PRBS. Repeating the above operations, the PRBS with a predetermined number of bits is generated. The PRBS with a predetermined number may be an 8-bit PRBS, the value range of which is from 0 to 255. The sync signal may be generated at the encryption apparatus 200. For ensuring that the PRBS generated from the encryption apparatus 200 is identical with a corresponding PRBS generated from a decryption apparatus to be described hereafter, the encryption apparatus 200 transmits the sync signal to the decryption apparatus, according to which a 15-bit shifting register of the decryption apparatus is initialized. The encryption apparatus 200 may transmit the sync signal to the decryption apparatus along with the encrypted image data, or may transmit the sync signal to the decryption apparatus independently.

One dividing point can be generated according to one PRBS. After a first PRBS is generated, the shifting register may generate a next PRBS by shifting one times or shifting a predetermine times. For example, if the 8-bits PRBS is required, the shifting register may generate one PRBS every shifting 8 times. The shifting register may also generate one PRBS every shifting one times. In this way, the seven high order bits of the PRBS current generated is the seven low order bits of the PRBS last generated, and the one low order bit of the PRBS current generated is the result of the logical operation.

For further understanding the present invention, a method for encryption image data is provided according to one embodiment of the present invention. The method encrypts the image data in an encryption terminal and is performed by: generating a dividing point depending on an encryption key; dividing image data into a plurality of image data blocks based on the dividing point; and rearranging the image data blocks according to a given sequence. Thus, the image data can be encrypted by disturbing the original sequence of the image data blocks. It should be noted that the image data may be so encrypted line by line, block by block or frame by frame. The encryption key may be predetermined or may be generated according to a given algorithm. There are several ways to generate the dividing point depending on the encryption key in the signal source terminal. The several ways can be understood with reference to FIGS. 3A-3C and corresponding description mentioned above.

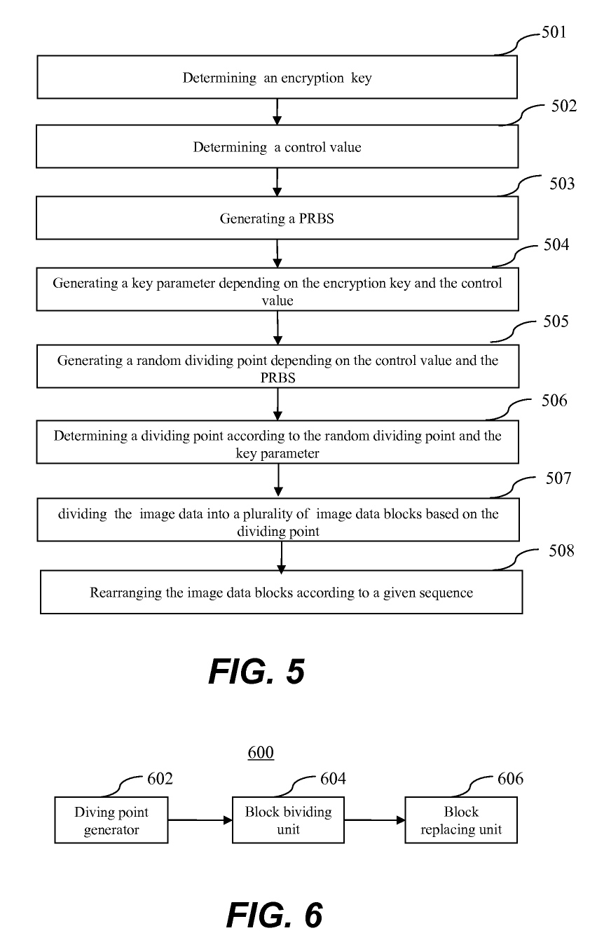

FIG. 5 is a schematic flowchart showing the encryption method according to one embodiment of the present invention. At 501, an encryption key is determined. The encryption key includes a plurality of 8-bit integer data. The encryption key may be predetermined or may be generated according to a given algorithm. At 502, a control value is determined. The control value may be predetermined or may be generated according to a given algorithm.

At 503, a PRSB is generated. In one embodiment, a 15-bit shifting register is taken as an example for generating the PRSB. The 15-bit shifting register is initialized under the control of a sync signal. The two highest order bits of the 15-bit shifting register are made a logic operation with each other in one period of the sync signal. Subsequently, the 15-bit shifting register shifts left with one bit and the result of the logical operation is stored into the lowest order bit of the 15-bit shifting register. Simultaneously, the result of the logical operation is outputted one binary digit of the PRBS. Repeating the above operations, the PRBS with a predetermined number of bits is generated. The PRBS with a predetermined number may be an 8-bit PRBS, the value range of which is from 0 to 255. The sync signal may be generated at the encryption terminal. For ensuring that the PRBS generated from the encryption terminal is identical with a corresponding PRBS generated from a decryption terminal, the encryption terminal transmits the sync signal to the decryption terminal. The encryption terminal may transmit the sync signal to the decryption terminal along with the encrypted image data, or may transmit the sync signal to the decryption terminal independently.

The process 501, the process 502 and the process 503 do not have to follow a distinct sequence. The processes 501, 502, and 503 may be performed successively, or may be performed simultaneously. At 504, a key parameter is generated depending on the encryption key and the control value. For example, if the control value is 7, the seventh integer data from low order to high order of the encryption key is selected as the key parameter.

At 505, a random dividing point is generated depending on the control value and the PRBS. For example, the control value and the PRBS are made a logical operation such as an XOR operation, an AND operation, an OR operation, or a NXOR operation with each other, and the result of the logical operation is taken as the random dividing point.

Again the process 504 and the process 505 do not have a distinct sequence and may be performed successively or simultaneously. At 506, a dividing point is determined according to the random dividing point and the key parameter. For example, the dividing point and the key parameter are made a logical operation such as an XOR operation, an AND operation, an OR operation, or an NXOR operation with each other, and the result of the logical operation is taken as the dividing point.

At 507, the image data is divided into a plurality of image data blocks based on the dividing point. The image data may be divided line by line, block by block or frame by frame. Namely, one line of, one block of or one frame of image data may be divided at a time. At 508, the image data blocks are rearranged according to a given sequence. Thus, the image data can be encrypted by disturbing arrangement sequence of the image data blocks

The encryption key, the control value, the given sequence is changeable at any moment during the image data transmission as long as these parameters in the encryption terminal are consistent with that in the decryption terminal. As described above, the encryption apparatus and method according to one embodiment of the present invention are introduced in detail. Next, a decryption apparatus and a decryption method are provided according to one embodiment of the present invention.

FIG. 6 is a schematic block diagram showing the decryption apparatus 600 according to one embodiment of the present invention. In FIG. 6, the decryption apparatus 600 is configured for decrypting encrypted image data from the encryption apparatus 200 and comprises a dividing point generator 602, a block dividing unit 604 and a block replacing unit 606.

The dividing point generator 602 generates a dividing point depending on a decryption key and outputs the dividing points to the block dividing unit 604. The decryption key consists of a plurality of 8-bit integer data. The decryption key may be predetermined or may be generated according to a given algorithm. The block dividing unit 604 divides encrypted image data into a plurality of image data blocks based on the received dividing point and outputs the image data blocks to the block replacing unit 606. The block replacing unit 606 replaces the image data blocks according to the given sequence which is transmitted from the encryption apparatus 200. Thus, the encrypted image data can be decrypted by replacing arrangement sequence of the image data blocks. It should be noted that the image data may be decrypted line by line, block by block or frame by frame. Namely, one line of, one block of or one frame of image data may be decrypted by the decryption apparatus 600 at a time.

The number of image data blocks divided by the block dividing unit 604 may be predetermined. Accordingly, the dividing point generator 602 is required to provide corresponding number of dividing points. Namely, the number of image data blocks corresponds to the number of dividing points. For ensuring efficient decryption, the image data blocks divided in the decryption apparatus 600 is identical with corresponding image data blocks divided in the encryption apparatus 200 so that the image data blocks can be replaced without any change.

The dividing point generator 602 in the decryption apparatus 600 has a substantially same configuration with the dividing point generator 202 in the encryption apparatus 200. The specific description of the dividing point generator 602 refers to corresponding description to FIGS. 3A-4, which is omitted here for simplicity.

The control value, the encryption key and the PRBS in the encryption apparatus 200 may be identical with the control value, the decryption key and the PRBS in the decryption apparatus 600 in real-time.

The decryption method according to one embodiment of the present invention decrypts the encrypted image data at the decryption terminal and is performed by: generating a dividing point depending on a decryption key; dividing the encrypted image data into image data blocks being identical with corresponding image data blocks divided in the encryption terminal based on the dividing point; and replacing the image data blocks according to the given sequence which is transmitted from the encryption terminal. Thus, the encrypted image data can be decrypted by replacing arrangement sequence of the image data blocks. It should be noted that the image data may be decrypted line by line, block by block or frame by frame. Namely, one line of, one block of or one frame of image data may be decrypted at a time.

The decryption key may be predetermined or may be generated according to a given algorithm. There are several ways to generate the dividing point depending on the decryption key in the signal destination terminal. The several ways can be understood with reference to FIGS. 3A-3C and corresponding description mentioned above.

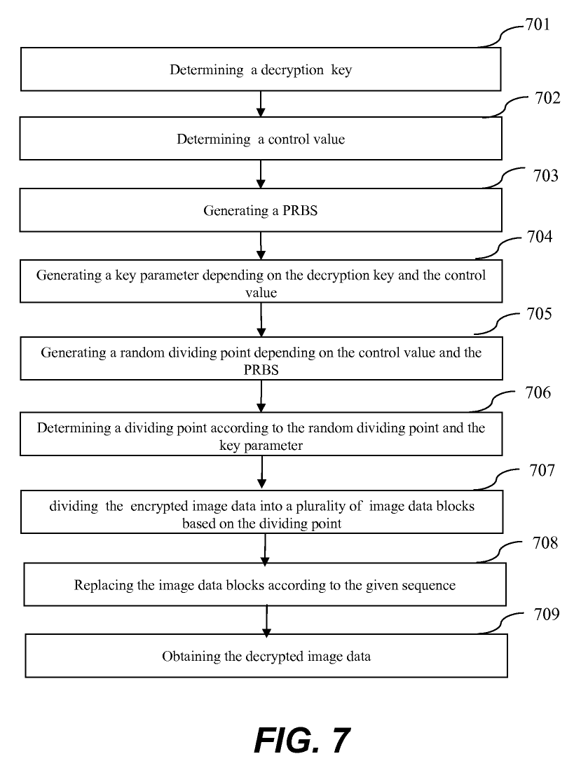

FIG. 7 is a schematic flowchart showing the decryption method according to one embodiment of the present invention. At 701, a decryption key is determined. The decryption key consists of a plurality of 8-bit integer data. The decryption key may be identical with the encryption key. At 702, a control value is determined. The control value may be identical with the control value in the encryption apparatus. At 703, a PRSB is generated. For example, a 15-bit shifting register is initialized under the control of a sync signal firstly. The two highest order bits of the 15-bit shifting register are made an XOR operation with each other in one period of the sync signal. Subsequently, the 15-bit shifting register shifts left with one bit and the result of the logical operation is stored into the lowest order bit of the 15-bit shifting register. Simultaneously, the result of the logical operation is outputted one binary digit of the PRBS. Repeating the above operations, the PRBS with a predetermined number of bits is generated. The sync signal comes from the encryption apparatus.

At 704, a key parameter is generated depending on the decryption key and the control value. At 705, a random dividing point is generated depending on the control value and the PRBS. At 706, a dividing point is determined according to the random dividing point and the key parameter. At 707, the encrypted image data is divided into a plurality of image data blocks being identical with the image data blocks divided in the encryption method based on the dividing point. The process of dividing the encrypted image data is performed by: calculating length of each image data block of the encrypted image data according to the dividing points and the given sequence; determining position of each image data block in the encrypted image data according to corresponding length of each image data block; dividing the encrypted image data into the image data blocks corresponding position of each image data block in the encrypted image data.

At 708, the image data block is replaced according to the given sequence. At 709, the decrypted image data is obtained. By same processing, the control value, the encryption key and the PRBS in the decryption terminal must be same with the control value, the decryption key and the PRBS in the encryption terminal. For example, as long as the shifting registers are initialized in same way in the encryption terminal and the decryption terminal, and make same logical operation to the same bits thereof, the PRBS generated from the PRBS register must be same.

In a word, the image data is encrypted by dividing the image data into a plurality of image data blocks and disturbing arrangement sequence of the image data blocks, and the encrypted image data is decrypted by dividing the encryption image data into a plurality of image data blocks being identical with corresponding image data blocks divided in the encryption process and replacing the image data blocks. This encryption algorithm of the present invention is simple to implement, thereby decreasing the complexity to decrypt the image data. If there are no the correct decryption key, the correct control value or the correct given sequence in the decryption terminal, the encrypted image can't be decrypted correctively.

For distinguishing the dividing points in the encryption terminal from the dividing points in the decryption, the former is called as the encryption dividing and the latter is called as the decryption dividing point.

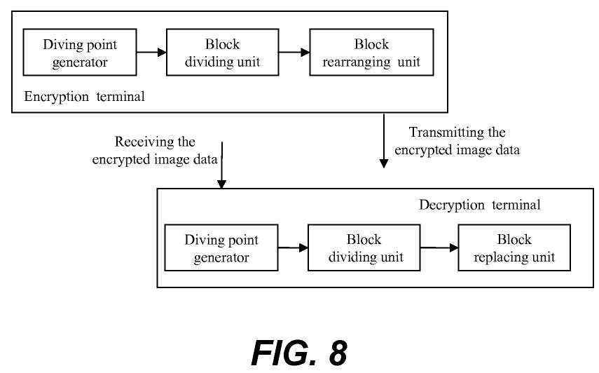

FIG. 8 is a schematic block diagram showing a system for encrypting/decrypting image data according to one embodiment of the present invention. In FIG. 8, the system comprises an encryption terminal and a decryption terminal. The encryption terminal is configured for generating a dividing point according to the depending on an encryption key, dividing the image data into image data blocks based on the dividing point and rearranging the image data blocks according to a given sequence. The decryption terminal is configured for generating a dividing point according to the depending on a decryption key, dividing the image data into image data blocks being identical with corresponding data blocks divided in the encryption terminal based on the dividing point and replacing the image data blocks according to the given sequence.

The encryption terminal comprises a dividing point generator, a block dividing unit and a block rearranging unit. The dividing point generator generates a dividing point depending on an encryption key and outputs the dividing points to the block dividing unit. The encryption key consists of a plurality of 8-bit integer data. The encryption key may be predetermined or may be generated according to a given algorithm. The block dividing unit divides image data into image data blocks based on the received dividing point and outputs the image data blocks to the block rearranging unit. The block rearranging unit rearranges the image data blocks according to a given sequence.

The decryption terminal comprises a dividing point generator, a block dividing unit and a block replacing unit. The dividing point generator generates a dividing point depending on a decryption key and outputs the dividing points to the block dividing unit. The decryption key consists of a plurality of 8-bit integer data. The decryption key may be predetermined or may be generated according to a given algorithm. The block dividing unit divides encrypted image data into image data blocks based on the received dividing point and outputs the image data blocks to the block replacing unit. The block replacing unit replaces the image data blocks according to a sequence reversed to the given sequence.

Next, a television signal is taken as an example to explain the encryption/decryption technique of the present invention. The encryption key such as six 10-bit integer data is identical with the decryption key. The encryption terminal and the decryption terminal have same control data such as 5, so the fifth integer data from low order to high order of the six 10-bit integer data is selected as the key parameter. The encryption terminal and the decryption terminal generate same PRBSs with ten bits. In addition, the number of image data blocks divided from one line of image data is determined, e.g. the number is 4. The given sequence of the image data blocks is 3, 1, 4, and 2.

Provided that each line of the image data has 720 pixels. The encryption terminal orderly generates three dividing points as one group. In this example, the three dividing points respectively are 400, 150 and 572. One line of the image data is divided into four image data blocks according to the group of dividing points. As a result, the first data block is the pixels from 1 to 150 and the length of the first data block is 120, the second data block is the pixels from 151 to 400 and the length of the second data block is 250, the third data block is the pixels from 401 to 572 and the length of the third data block is 172, and the fourth data block is the pixels from 573 to 720 and the length of the fourth data block is 148. The four image data blocks are rearranged according to the given sequence 3, 1, 4, 2. After the image data block is rearranged, the first image block of the image data is taken as the second image blocks of the encrypted image data, the second image block of the image data is taken as the fourth image blocks of the encrypted image data, the third image block of the image data is taken as the fourth image block of the encrypted image data, the fourth image block of the image data is taken as the third image block of the encrypted image data. Thus, one line of the encrypted image is obtained according to one line of image data.

The dividing point is a reference for dividing one line of the image data. Hence, the value of the dividing point requires to be less than a total number of pixels in one line of image data. If the value of the dividing point is larger than the total number of the pixels in one line of image data, some techniques which ordinary people in the art know may be applied to the dividing point for ensuring the value of the dividing point less than the total number of the pixels in one line of image data. For example, provided that the total number of the pixels in one line of image data is 160 and the value of the dividing point is 180, the dividing point may be processed according to following formula: the dividing point=160*180/256, thereby ensuring the value of the dividing point less than the total number of the pixels in one line of image data.

The decryption terminal generates three same diving points 400, 150 and 572. One corresponding line of the encrypted image data is divided into fourth image data blocks according the three diving points. Specifically, according to the given sequence 3, 1, 4, 2 and the dividing points 400, 150, 572, the lengths of first, second, third and fourth image data blocks of the encrypted image data are calculated and respectively are 172, 120, 148, 250. Thus, the four image data blocks of the encrypted image which are identical with corresponding image data blocks divided in the encryption terminal are obtained. Subsequently, the four image data blocks are replaced according to the given sequence. Only one line of image data requires to be buffered in the embodiment of the present invention, thereby greatly decreasing the storage cost.

The above description is related to encrypt one line of the image data at a time. The way of encrypting a plurality of lines of image data at a time can also be introduced in the present invention. At that time, the dividing point generator may generate a line dividing point for dividing the image data in a line direction and a row dividing point for dividing the image data in a row direction, thereby the plural lines of image data are divided into a plurality of image data blocks.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for information security, comprising:
generating a number of encryption dividing points in accordance with an encryption key;
dividing image data into a plurality of image data blocks according to the encryption dividing points;
rearranging the image data blocks according to a given sequence to produce encrypted image data.

2. The method according to claim 1, further comprising:
generating a number of dividing points in accordance with a decryption key;
dividing the encrypted image data into a plurality of image data blocks according to the decryption dividing points, a number of the image data blocks that have been divided identical with a number of the corresponding image data blocks divided according to the dividing points; and
replacing the image data blocks according to the given sequence to produce decrypted image data.

3. The method according to claim 2, wherein the image data is encrypted by lines, by blocks or by frames, and wherein the image data is decrypted by lines, by blocks or by frames, correspondingly.

4. The method according to claim 2, wherein the decryption key is identical with the encryption key, and wherein the decryption dividing points are identical with the encryption dividing points.

5. The method according to claim 4, wherein said dividing the encrypted image data is performed by:
calculating a length of each of the image data blocks according to the decryption dividing points and the given sequence;
determining a position of each of the image data blocks in the encrypted image data according to the length of each of the image data blocks; and
dividing the encrypted image data into the image data blocks in accordance with a corresponding position of each of the image data blocks in the encrypted image data.

6. The method according to claim 2, wherein the number of the image data blocks is predetermined, and wherein the number of the dividing points in one group corresponds to the number of the image data blocks.

7. The method according to claim 2, wherein said generating a number of dividing points comprises one of:
generating one encryption dividing point according to the encryption key and a control value;
generating one encryption dividing point according to the encryption key and a pseudo random binary sequence; or
selecting a key parameters according to the encryption key and a control value; and
generating a random encryption dividing point according to a pseudo random binary sequence and the control value; and generating one encryption dividing point according to the random encryption dividing point and the key parameter.

8. The method according to claim 7, wherein said generating a number decryption dividing points comprises one of:
generating one decryption dividing point according to the decryption key and a control value;
generating one decryption dividing point according to the decryption key and a generated pseudo random binary sequence; and
selecting a key parameters according to the decryption key and a control value; generating a random decryption dividing point according to a pseudo random binary sequence and the control value; and generating one decryption dividing point according to the random decryption dividing point and the key parameter.

9. The method according to claim 8, wherein the control value, the PRBS and the encryption key in the process of generating the group of encryption dividing points are consistent with the control the control value, the PRBS and the decryption key in the process of generating the group of decryption dividing points, respectively.

10. An encryption apparatus comprising:
a dividing point generator for generating a dividing point depending on an encryption key;
a block dividing unit for dividing image data into a plurality of image data blocks based on the dividing point; and
a block rearranging unit for rearranging the image data blocks according to a given sequence to produce encryption image data.

11. The encryption apparatus according to claim 10, wherein the image data is encrypted by lines, by blocks or by frames.

12. The encryption apparatus according to claim 11, wherein the number of the image data blocks is predetermined, and wherein corresponding number of the dividing points is generated by the dividing point generator for each line of the image data, each block of the image data, or each frame of the image data.

13. The encryption apparatus according to claim 10, wherein
the dividing point generator comprises a control value providing unit, an encryption key providing unit and a dividing point determining unit, and wherein the control value providing unit is configured for providing a control value, the encryption key providing unit is configured for providing the encryption key, and the dividing point determining unit is configured for generating the dividing point according to the control value and the encryption key;
the dividing point generator comprises a PRSB generator, an encryption key providing unit and a dividing point determining unit, and wherein the PRSB generator is configured for providing a PRSB, the encryption key providing unit is configured for providing the encryption key, and the dividing point determining unit is configured for generating the dividing point according to the control value and the encryption key; or
the dividing point generator comprises a PRBS generator, a control value providing unit, a random dividing point generator, an encryption key providing unit, a key parameter determining unit and a dividing point determining unit, and wherein the PRBS generator is configured for generating a PRBS, the control value providing unit is configured for providing a control value, the random dividing point generator is configured for generating a random dividing point, the encryption key providing unit is configured for providing the encryption key, the key parameter determining unit is configured for determining a key parameter according to the encryption key and the control value, and the dividing point determining unit is configured for determining the dividing point according to the random dividing point and the key parameter.

14. A decryption apparatus, comprising:
a dividing point generator for generating a dividing point depending on a decryption key;
a block dividing unit for dividing encrypted image data into image data blocks based on the dividing point; and
a block replacing unit for replacing the image data blocks according to a given sequence to produce decryption image data.

15. The decryption apparatus according to claim 14, wherein the image data is decrypted by lines, by blocks or by frames.

16. The decryption apparatus according to claim 15, wherein the number of the image data blocks is predetermined, and wherein corresponding number of the dividing points is generated by the dividing point generator for each line of the image data, each block of the image data, or each frame of the image data.

17. The decryption apparatus according to claim 14, wherein
the dividing point generator comprises a control value providing unit, an encryption key providing unit and a dividing point determining unit, and wherein the control value providing unit is configured for providing a control value, the encryption key providing unit is configured for providing the encryption key, and the dividing point determining unit is configured for generating the dividing point according to the control value and the encryption key;
the dividing point generator comprises a PRSB generator, an encryption key providing unit and a dividing point determining unit, and wherein the PRSB generator is configured for providing a PRSB, the encryption key providing unit is configured for providing the encryption key, and the dividing point determining unit is configured for generating the dividing point according to the control value and the encryption key; or
the dividing point generator comprises a PRBS generator, a control value providing unit, a random dividing point generator, an encryption key providing unit, a key parameter determining unit and a dividing point determining unit, and wherein the PRBS generator is configured for generating a PRBS, the control value providing unit is configured for providing a control value, the random dividing point generator is configured for generating a random dividing point, the encryption key providing unit is configured for providing the encryption key, the key parameter determining unit is configured for determining a key parameter according to the encryption key and the control value, and the dividing point determining unit is configured for determining the dividing point according to the random dividing point and the key parameter.

18. A system for information security, comprising:
an encryption apparatus, comprising:
a dividing point generator for generating a group of encryption dividing points depending on an encryption key;
a block dividing unit for dividing image data into a plurality of image data blocks based on the group of encryption dividing points; and
a block rearranging unit for rearranging the image data blocks according to a given sequence to produce encryption image data;
a decryption apparatus, comprising:
a dividing point generator for generating a group of decryption dividing points depending on a decryption key;
a block dividing unit for dividing encrypted image data into image data blocks being identical with corresponding image data blocks divided in the encryption apparatus based on the group of decryption dividing points; and
a block replacing unit for replacing the image data blocks according to the given sequence to produce decryption image data.

19. The system according to claim 18, wherein the number of the image data blocks is predetermined, and wherein the number of the dividing points in one group corresponds to the number of the image data blocks.

20. The system according to claim 18, wherein the image data is encrypted by lines, by blocks or by frames, and wherein the image data is decrypted by lines, by blocks or by frames, corresponding.

21. The system according to claim 18, wherein the decryption key is identical with the encryption key, and wherein the decryption dividing points are identical with the encryption dividing points.

22. The system according to claim 21, wherein the block dividing unit of the decryption apparatus divides the encrypted image data into the image data blocks by:
calculating length of each image data block of the encrypted image data according to the decryption dividing points and the given sequence;
determining position of each image data block in the encrypted image data according to corresponding length of each image data block;
dividing the encrypted image data into the image data blocks corresponding position of each image data block in the encrypted image data.
